(19) United States
(12) Patent Application Publication
(10) Pub. No.: US 2012/0102408 A1
(43) Pub. Date: Apr. 26, 2012

(54) SYSTEMS AND METHODS FOR SERVICE PROVISION BASED ON EVENTS

(76) Inventors: Zhenzhen ZHAO, Evry (FR); Noel CRESPI, Paris (FR)

(21) Appl. No.: 12/909,898

(22) Filed: Oct. 22, 2010

(51) Int. Cl. G06F 3/01

(52) U.S. Cl. 715/738

(57) ABSTRACT

A computer implemented method for providing an events based user interface over a network is provided. The method includes receiving by the computer, event information comprising an event date and at least one of an event category and an event location related to an event, generating a subset of one or more services related to the event from a computerized database, the computerized database comprising a list of available services, receiving by the computer, a selection from the subset, and providing via the network, user interface data causing display of a user interface comprising at least a portion of the event information and an access element linked to the one or more services based on the selection, the access element enabling interaction with the selected one or more services.

### FIELD OF THE DISCLOSURE

The present disclosure relates to network based user interfaces, and more particularly, to a user interface configured to provide access to one or more services based on a user defined event.

### BACKGROUND OF THE DISCLOSURE

Web mashups, a form of content aggregation, can provide integration of information and services in a desirable visual manner. Although various tools have been available for mashup development, creating a mashup may not be a simple task when viewed from the point of end users. This may be true because, for example, an end user may not be adequately informed as to the available information services and/or development tools for creating a desired mashup.

Studies have been performed on end users' motivation on creating a mashup, feedback on users' requirements, usability of mashups and factors for acceptance of mashups. However, formal models for user acceptance of mashups, based on user studies are still lacking, or confined solely to enterprise mashups, and may not reflect the attitudes of a general user base as to creation of desirable mashups.

Commercial platforms like iGoogle, Netvibes, and Pageflakes may provide a convenient way for users to aggregate selected services, referred to as widgets or gadgets in their personal environment (also referred to as a “dashboard”). Such systems exhibit large service databases and often permit access to third parties for increased system functionality, however, a rich service database without more (e.g., assistance in selecting from such a database) may lead to an undesirable user experience.

Tracking a user's intent and preferences for automatic service discovery, selection and recommendation may therefore be desirable. As web services become more prevalent, tools may be useful to help users find, filter and integrate these services into a desired personal environment. Such tools should guide users in dynamic composition of web services, for example, by using semantic service descriptions to match and filter relevant services at each step of service composition. An intelligent decision making framework for selection of a list of useful services from a pool of similarly appearing services should also be provided.

Therefore, it is desirable to provide systems and methods for assisting users to aggregate services in a manner that is more easily understood and results in an improved user experience.

It is accordingly an object of the present disclosure to provide systems and methods for creating a mashup based on daily activities, e.g., events, to which an end-user can relate and understand. Such systems and methods, in which a user creates an event and specifies event attributes (what, when, where, who), can receive contextual related services that may be associated with the event in an aggregated manner.

It is further an object of the present disclosure to provide a user with simplified access to available services and tools, and to enable system recommendation and user selection of such related services and tools. Recommendations may be made according to a functional description of the event (e.g., event hierarchy) and user selection history, among other things.

### SUMMARY

In accordance with the present disclosure, a computer implemented method for providing an events based user interface over a network is provided. The method includes receiving by the computer, event information comprising an event date and at least one of an event category and an event location related to an event, generating a subset of one or more services related to the event from a computerized database, the computerized database comprising a list of available services, receiving by the computer, a selection from the subset; and providing via the network, user interface data causing display of a user interface comprising at least a portion of the event information and an access element linked to the one or more services based on the selection, the access element enabling interaction with the selected one or more services.

By providing such a method, a user may be enabled to perform content aggregation (i.e., create a mashup) based on elements related to daily life (e.g., events) thus potentially reducing complication associated with creation of mashups. Further, a user may benefit from improved event planning based on the mashup associated with the event because of the availability of relevant services. Moreover, complications associated with user selection of available services may be mitigated based on logic associated with the system and methods described herein.

According to some embodiments, a user interface, which may be rendered in HTML, PHP, JavaScript, or other appropriate data and combinations thereof for causing display of an interface and including at least some information relevant to the event and at least some means for accessing one of the selected services (e.g., a hyperlink), is transmitted over the network, to a user device for display by the user device.

The user interface can be in a calendar format and/or may include a calendar representation.

The access element can be linked to the one or more services and/or the visual representation of the one or more services is displayed within a date labeled subdivision of the calendar.

The generating can be further based on one or more previous user selections, for example, a user history within a browser and/or a user history of service selections, and/or data associated with a user profile (e.g., user location, user language preference, etc). In addition, the generating can be based on one or more of an event location, an event recurrence profile, an event attendee, etc.

Particularly, services may be suggested based on various factors, such as requests from one or more service providers. A service provider may wish to promote the service provider's service within a listing of services, and may therefore provide consideration (e.g., a fee) in return for highlighting the service of the provider.

The access elements can be presented in at least one of a widget format, a window format, and a hyperlink format, among others. Widget format shall mean a format wherein a service is interacted with and displayed within a current user interface. Window format shall mean a format wherein a service is interacted with and displayed within its own window and/or browser (e.g., a pop-up window) on a user computer. Link format shall mean a shape or representation provided within a user interface, which may or may not connote a particular type of service represented by an access element, which may, upon actuation (e.g., clicking), result in rendering accessible a widget format service, a window format service, or any other suitable display of a service.

Event categories can be chosen from at least one or more of a meeting event, a travel event, a fashion/shopping event, a party, a cooking event, a world event, a business/financial event, an art/literature event, a history based event, a learning event, a religious event, a health and fitness event, and a sporting event.

The event information may further comprise at least one event attendee. The at least one event attendee may be an attendee other than the user. Upon receiving one or more event invitee selections, the system may recognize that an event is a social and/or business event instead of a personal event based on the additional invitees. Such recognition may enable presentation of additional services in the subset of services (e.g., communication/social services).

The service can be selected from at least one of a locally hosted service and a web hosted service (e.g., a web service).

The available services may be selected from one or more of a language translator, a to-do list service, a messaging service, a bookmarking service, a trip booking service, a trip advisor, a calculator, a route planner, a point of interest locator, a currency converter, a classified advertisement provider, a budget planner, a recipe finder, a news service, a banking service, a game provider, a video provider, a book provider, a tour provider, a weather service, a vehicle rental service, a restaurant finder, a shopping service, and a fitness service.

The network can be the Internet, a local area network, a mobile network and/or other network or combination of networks.

The subset of one or more services related to the event can be displayed to the user to enable selection of one or more services. Generation of the subset of one or more services related to the event can be further based on an event category hierarchy. The event hierarchy may be structured having a first level based on a an event type, a second level based on related functionality associated with particular event types, and a third level associated with related service providing such functionality.

Each level of the event hierarchy as well as individual event categories within an event hierarchy may be reusable. In other words, certain categories and/or functionalities may apply to one or more event categories, and may therefore be reused at one or more locations within a logical hierarchy.

A user's selection of services may be saved, and may be used to generate a selection history. Selections in such a history may be ranked based on the event category and the user selection history, among other things. The ranking can be based on at least one of a frequency of selection by the user and a frequency of selection among a plurality of users as related to particular event categories.

The access elements can be configured to provide request origin information to a service host. Such information may be selected from at least one of a user ID, an IP address, a domain name, and cookie information.

The user interface can be configured to enable a user to assign one or more default services to an event category. Such a configuration may enable a user to improve efficiency during creation of a desired mashup.

The user interface can further be configured to allow the user to subscribe to a third-party provider, the third-party provider having authority to add to the user interface one or more access elements related to the event, independently of the user. The user may provide varying permissions to various third-party providers to enable addition, deletion, and/or editing of such access elements.

One or more reminders associated with an event can be provided to the user, particularly where the user indicates a preference to receive such reminders. The reminders can include a reference to the event and/or references to the one or more selected services and/or access elements.

When a user has utilized one or more of the services to reserve and/or purchase services (e.g., a hotel room, a rental car, etc.) a confirmation element may be provided within the user interface and/or within an event interface.

According to some embodiments, user profiles associated with a current user and/or one or more event attendees may be generated and/or stored, for example within a database. Such user profiles may be identified and accessed for purposes of providing suggestions based on the user profiles.

A listing of suggested services may also be modified based on remaining time before occurrence of the event.

According to exemplary embodiments of the present disclosure, a computer system configured to provide one or more user interface elements in connection with an event is provided. The computer system includes a database comprising one or more available services, a receiving module configured to receive event information, the event information comprising an event date and at least one of an event category and an event location related to the event, a generating module configured to generate a subset of one or more services related to the event based on the event information and the available services, a selection module configured to receive a selection of at least one of the one or more services, and a user interface module configured to generate user interface data causing display of a user interface comprising at least a portion of the event information and an access element linked to the one or more services and/or a visual representation of the one or more services based on the selection, the access element and/or visual representation enabling interaction with the selected one or more services.

Additional objects and advantages of the present disclosure will be set forth in part in the description which follows.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate one or more embodiments of the present disclosure and together with the description, serve to explain the principles of the present disclosure. In the drawings,

FIG. 1 is an illustration showing an exemplary calendar based user interface according to embodiments of the present disclosure;

FIG. 2 is a block diagram illustrating an exemplary method for delivery of services based on one or more events;

FIG. 3A is an exemplary event information interface enabling input by a user related to an event in time;

FIG. 3B is an illustration of an exemplary service selection interface enabling user selection of one or more services from a subset of available services for incorporation within a user interface and association with an event;

FIG. 3C is an illustration showing an exemplary user interface including one or more access elements in addition to a display of associated services in widget format according to embodiments of the present disclosure;

FIG. 4 is an exemplary block diagram illustrating one methodology for modifying a subset of services based on user selections;

FIG. 5 is a diagram illustrating an exemplary event hierarchy;

FIG. 6A is a diagram illustrating one exemplary branch of the event hierarchy of FIG. 5, consistent with embodiments of the present disclosure;

FIG. 6B is an exemplary event category hierarchy consistent with embodiments of the present disclosure is shown at FIG. 6A;

FIG. 7 is an illustration of an exemplary architecture consistent with embodiments of the present disclosure;

FIG. 8A is a block diagram illustrating an exemplary architecture associated with a client device consistent with embodiments of the present disclosure; and

FIG. 8B is a block diagram illustrating an exemplary architecture associated with a server device consistent with embodiments of the present disclosure.

### MORE DETAILED DESCRIPTION

Reference will now be made in detail to the exemplary embodiments of the present disclosure, examples of which are provided and illustrated in the accompanying drawings. Wherever possible, the same reference numbers will be used throughout the drawings to refer to the same or like parts.

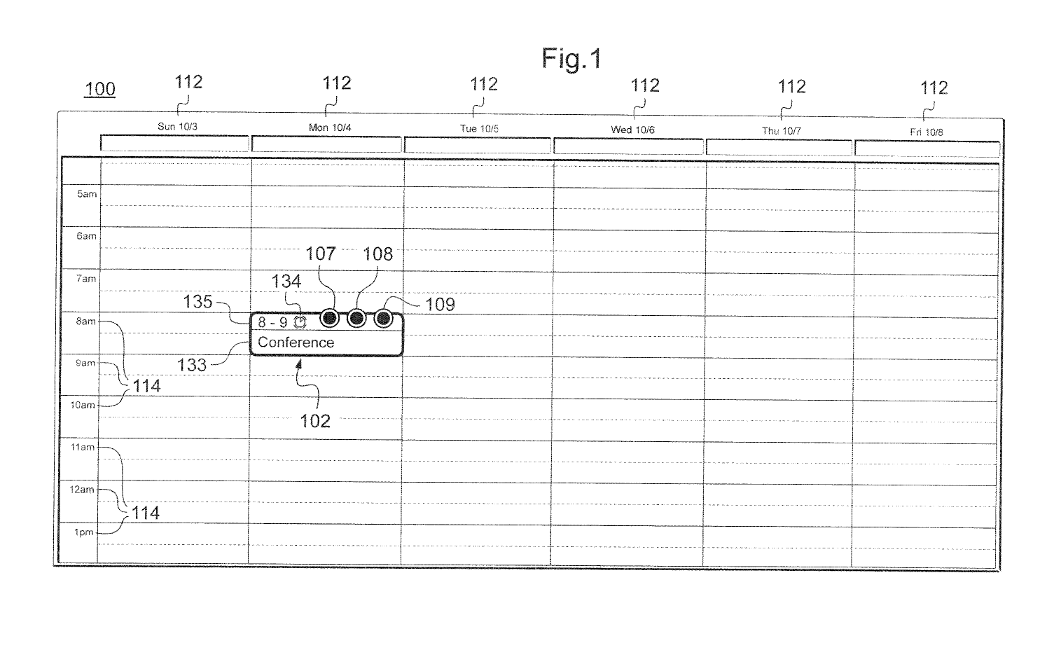

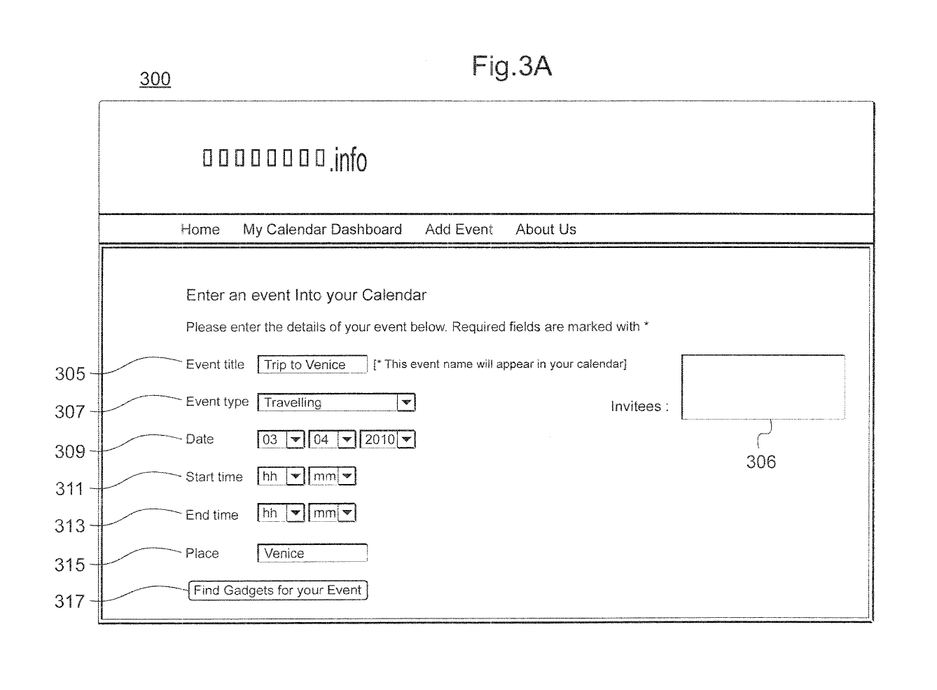

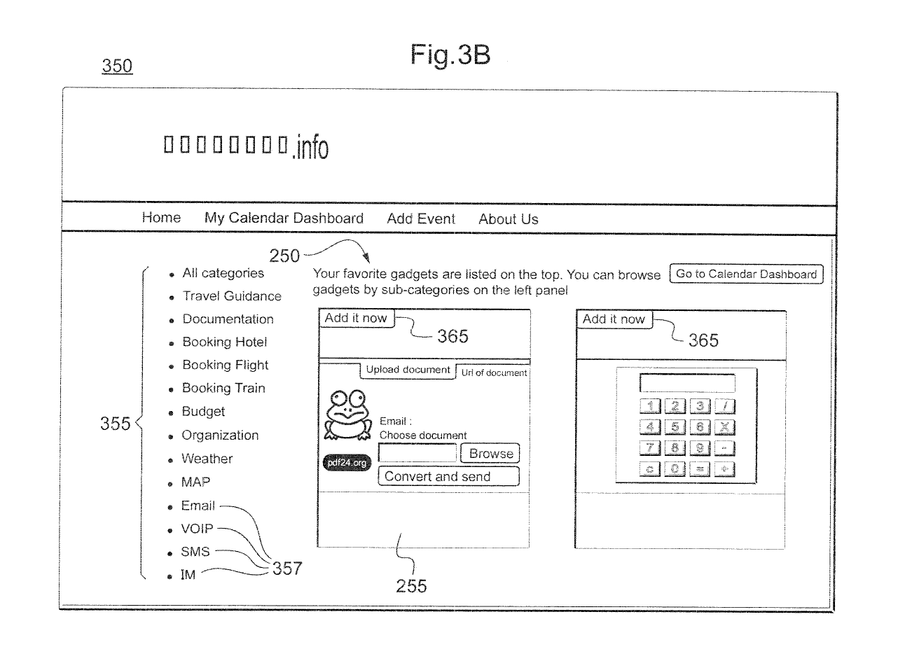

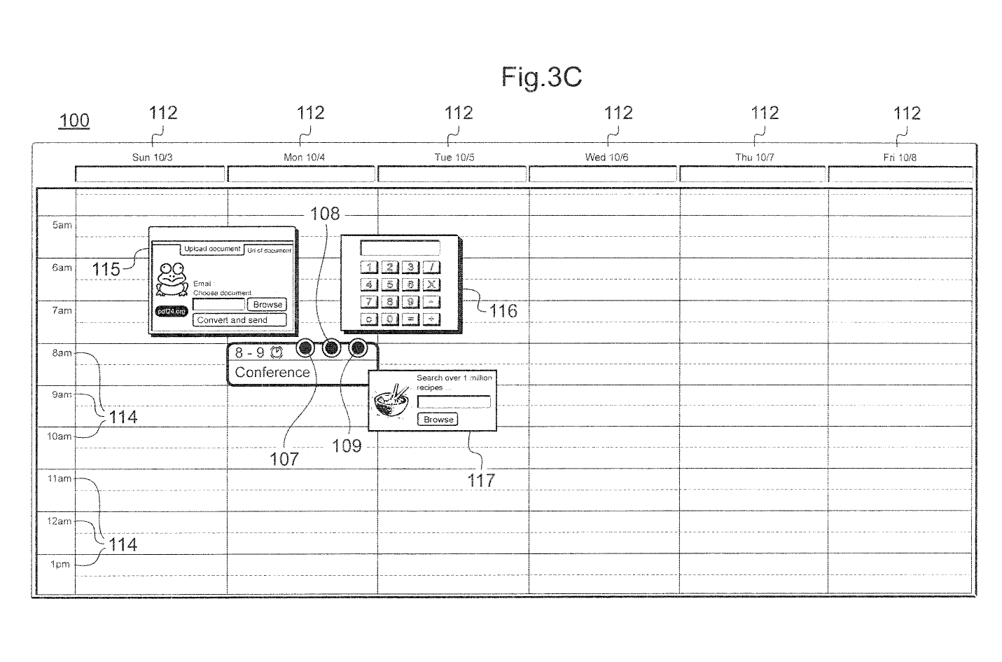

Systems and methods of the present disclosure enable a user to create one or more desired mashups based on everyday events occurring in the life of the user and/or other entities. FIG. 1 is an illustration showing an exemplary user interface 100 displaying a mashup showing an event 102, event 102 showing at least a portion of information associated with an event in time. In the present example, an event title 133, an event alert indicator 134, and an event time period 135 are shown. In addition, access elements 107, 108, and 109 are visually displayed in relation to event 102, access elements 107-109 providing access to one or more services 115, 116, and 117 (shown at FIG. 3C in widget format) based on a selection of a user.

Access elements 107-109 are shown with dashed line and semi-transparent at FIG. 1 to demonstrate that access elements 107-109 may or may not be initially present after adding information associated with event 102, for example, where a user has not yet made a selection of one or more available services, such a selection being discussed in greater detail below. Further, while three such access elements 107-109 are shown associated with event 102 within user interface 100, one of skill in the art will recognize that more or fewer access elements may be provided, and such access elements may take any desired shape or size, as desired. For example, two access elements may be provided having shapes which connote food/restaurants (e.g., shape of a fried chicken leg) while another two access elements may be provided, one having a shape which connotes lodging facilities (e.g., shape of a house) and the other having a shape connoting fuel/service stations (e.g., shape of a fuel pump). Each such connotation may relate to the type of service represented.

User interface 100 may be configured in a calendar format having one or more date representations 112 and one or more time representations 114 associated with each of the one or more date representations 112. Such an interface may be useful, for example, to break a particular day into any number of desirable time slots for associating one or more events 102. According to such an embodiment, user interface 100 may enable a user to add, edit, or delete one or more events 102 at any particular date and time as desired, for example, by clicking a time slot, an event 102, or otherwise indicating a desired action related to an event in time.

Notably, when user interface 100 is represented in calendar format, such calendar format may present any suitable organization of date/time slots. According to some embodiments, a calendar format may include five days of the business week (e.g., Monday to Friday), a seven day week (i.e., Monday-Sunday), all days in a month (e.g., thirty days of September), etc. Depending on the number of days displayed, displayed time representations 114 may be fewer or greater as desired. Thus, according to some embodiments, it may be desirable to provide drill down functionality to enable greater levels of granularity associated with time representations 114 as each date representation 112 is accessed.

According to some embodiments of the present disclosure, user interface 100 may be configured in a format other than a calendar, and may provide one or more calendar representations as part of user interface 100. For example, user interface 100 may present an event list which may enable drilling down to an event details page, which may provide access to access elements 107-109 as well as details regarding event 102 at a particular date and time. Such an event list may present event information in any suitable format to enable a user to select and view an event. Alternatively, access elements 107-109 may be accessible from such an events list view.

Access elements 107-109 may enable interaction with one or more services (e.g., web services, locally hosted service, etc.) selected by a user. Therefore, access elements 107-109 may function as hyperlinks, buttons, and/or any suitable element for indicating selection or actuation of an element. For example, where event 102 is a breakfast meeting, a restaurant finder service may be provided via access element 107 to be selected by a user and displayed in widget format as part of a mashup associated with event 102. A user viewing user interface 100 may therefore click on user element 107 to cause such service to become accessible for interaction within user interface 100, for example, in widget format (e.g., as shown at FIG. 3C). In the present example, such a service may be useful, for example, to enable the user to obtain food for serving during the meeting. Addition and selection of such services will be discussed in greater detail below.

Moreover, user interface 100 may enable a user to create one or more events by allocating an event to a particular date and time slot. Importantly, certain functionalities of calendar based scheduler systems will not be discussed in detail herein.

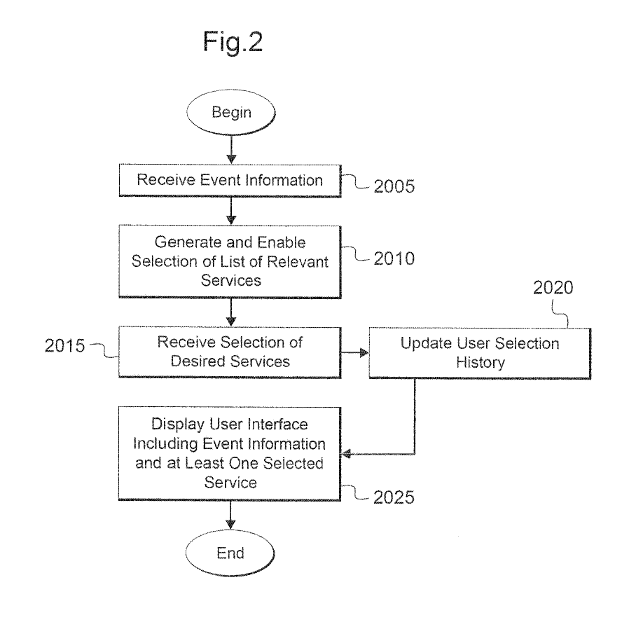

FIG. 2 is a block diagram illustrating an exemplary method for delivery of services based on one or more events. FIGS. 3A-C will be referenced during the discussion of FIG. 2 to aid in understanding embodiments of the present disclosure.

According to exemplary embodiments of the present disclosure, a user may access a calendar and scheduling provider or other suitable application for purposes of editing, storing, and displaying event information. For example, a calendar and scheduling provider may be accessed locally on a client device 104 and/or over a network such as a LAN or the Internet via communications with, for example, a server device 800. Exemplary calendar and scheduling providers may include Google Calendar, Yahoo Calendar, Outlook Calendar, etc. Such calendar and scheduling providers are configured to receive and store event information from one or more users of the system (step 2005).

For purposes of understanding, the exemplary event 102 to be described herein will be a conference which includes travel, however, one of skill in the art will recognize that any type and number of events in time are suitable for implementation with the systems and methods described herein.

FIG. 3A is an exemplary event information interface 300 enabling information input by a user related to an event 102 including date and time data. One of skill in the art will recognize that event information interface 300 may include data field textboxes, radio buttons, pushbuttons, checkboxes, tables, and tabs, list boxes, dropdowns, and any other suitable interface element related to input and receiving of event information.

According to some embodiments of the present disclosure, event information interface 300 may include an event title selector 305 to receive an event title, invitee selector 306 to enable addition of one or more event invitees, an event category selector 307 to receive an event category, an event date selector 309 to receive an event date, an event start time selector 309 to receive an event start time, and an event end time selector 313 to receive an event end time. Further, event information interface 300 may include an event location selector 315 to receive location information, and an entry actuator 317 for indicating a desire to continue with creation/editing of an event 102, among others. One of ordinary skill in the art will recognize that more or fewer parameters related to an event may be received as desired at step 2005. For example, a user may be enabled to configure reminders to be received and associated with event 102. Such reminders may include links and/or other references to services which have been associated with event 102.

Each of the elements 305-315 may receive information in any suitable manner, based on the type of interface element presented by event information interface 300. For example, a user may type information, speak information (speech recognition), click to select information, etc.

Event information interface 300 may be configured to guide a user through the steps of data entry, for example, by providing cues (e.g., visual, audible, locked fields etc.) or otherwise structuring event information interface 300. Further, according to some embodiments of the present disclosure, certain data entry fields may be prefilled based on, for example, a user profile and/or user preferences.

According to embodiments of the present disclosure, a user selects one or more categories associated with the event for which data has been entered using, for example, event category selector 307. For example, in addition to providing a time, a date, and a title, event category selector 307 may be provided as a dropdown selector having a pre-filled list of available event categories from which to select one or more event categories for the event 102. According to some embodiments, such a listing may be filtered based on, for example, other entered data (e.g., the event title) and/or one or more other parameters already existing in the system (e.g., user profile information, user default settings, etc.).

Event categories may include, for example, a meeting event, a travel event, a fashion/shopping event, a party, a cooking event, a world event, a business/financial event, an art/literature event, a history based event, a learning event, a religious event, a health and fitness event, and a sporting event, this list not intended to be exhaustive. Any other entertainment, business, and/or personal event categories, among others, may be implemented as desired and may be presented in any way enabling selection by a user.

While FIG. 3A illustrates a single dropdown selector as event category selector 307, it may be desirable to provide, for example, multiple dropdown selectors, a list box selector, a checkbox selector, and/or any other suitable elements for selecting more than one event category for a particular event 102. One of skill in the art will recognize that many occasions may be categorized by more than one event category, and the examples herein are not intended to be limiting.

Once a user has entered event information related to event 102, including an event category, the entered information may be received by, for example client device 104 and/or server 300. For example, client device 104 may transmit event information to server 300 via a network, such as, for example, the Internet. Upon receipt of such information, server 300 and/or client device 104 may undertake to generate a subset of system recommended services 405 to enable the user to select one or more services for providing in conjunction with event information within user interface 100 (step 2010). According to some embodiments of the present disclosure, a computerized database 806 comprising information (e.g., URL, title, etc.) regarding one or more available services may be queried and the results analyzed for generating the subset of system recommended services 405. In such embodiments, the queries used may be dynamically created based on the event information including the event category, among other things.

The generating may be performed by server 800 located remotely from the user and/or on client device 104 operated by the user. According to some embodiments, where the generating is performed on client device 104, a listing of available services may be stored on client device 104, transmitted to client device 104, and/or any combination thereof. For example, it may be desirable to determine whether a database 806 of available services present on client device 104 is up to date and includes all available services. Following a determination that database 806 is not current, a new listing of available services may be provided to the client device 104 for updating the database stored thereon, for example from server 800.

According to embodiments where the generating occurs remotely from the user, one or more servers 800 may provide relational database capabilities, as described below, to enable querying of a services database according to the even information provided by the user.

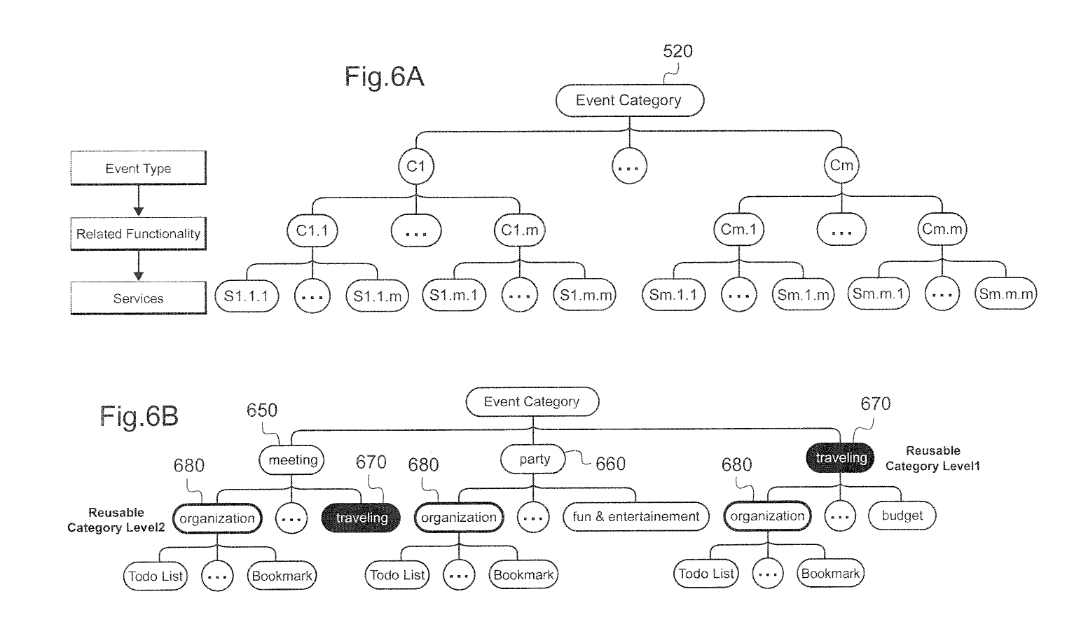

FIG. 3B is an illustration of an exemplary service selection interface 350 enabling user selection of one or more services from a subset of available services for incorporation within a user interface and association with an event. Service selection interface 350 may provide a listing of services 250, by, for example, title or other suitable identifier (e.g., a graphical identifier). According to some embodiments, and as shown at FIG. 2B, the subset of system recommended services 405 may be further organized using various criteria to simplify a user selection. For example, services in the subset may be grouped within a classification listing 355 with each classification 357 represented by a summary title, for example. According to some embodiments, classification listing 355 may be classified by service functionality as presented in an event hierarchy (e.g., as shown at FIG. 6B), with each classification being represented by, for example, a hyperlink or button. Upon accessing the associated hyperlink or button, a user may be presented with a listing of services falling under such a classification for selection. Thus, where the classification “Budget Planning” is provided as a hyperlink, a user accessing this classification may find available for selection, a calculator service, one or more budget tracking services, and one or more currency converters, this listing being exemplary only.

Further, service selection interface 350 may provide highlighted services 255, which may be presented with more or less emphasis as desired to draw the attention of the user. For example, highlighted services 255 may be provided based on a user's past selections, on preference given to one or more service providers (e.g., in return for payment), and/or for other suitable reasons. Highlighted services 255 may be, for example, expanded or otherwise highlighted to show up outside of a listing (e.g., classification listing 355) such that a user may be more inclined to select highlighted services 255. Moreover, it may be desirable that each element of classification listing 355, upon accessing the associated link, provides a separate highlighted service listing showing highlighted services 255 associated with that particular classification.

Using service selection interface 350, a user may select one or more services for inclusion with an event 102 by, for example, actuating a button 365 or other suitable element associated with a service (e.g., a link titled “Add it now”) (step 2015). While button 365 is described herein for purposes of understanding, one of ordinary skill in the art will recognize that any method for selecting or indicating a selection may be used.

Selection of one or more services may trigger a number of actions, such as for example, linking of the selected service to event 102 (e.g., via a linking table in the database) and placing the selected service among a list of final relevant services 410. In addition, selection may trigger an updating of a user selection history and a reordering of presented services (step 2020).

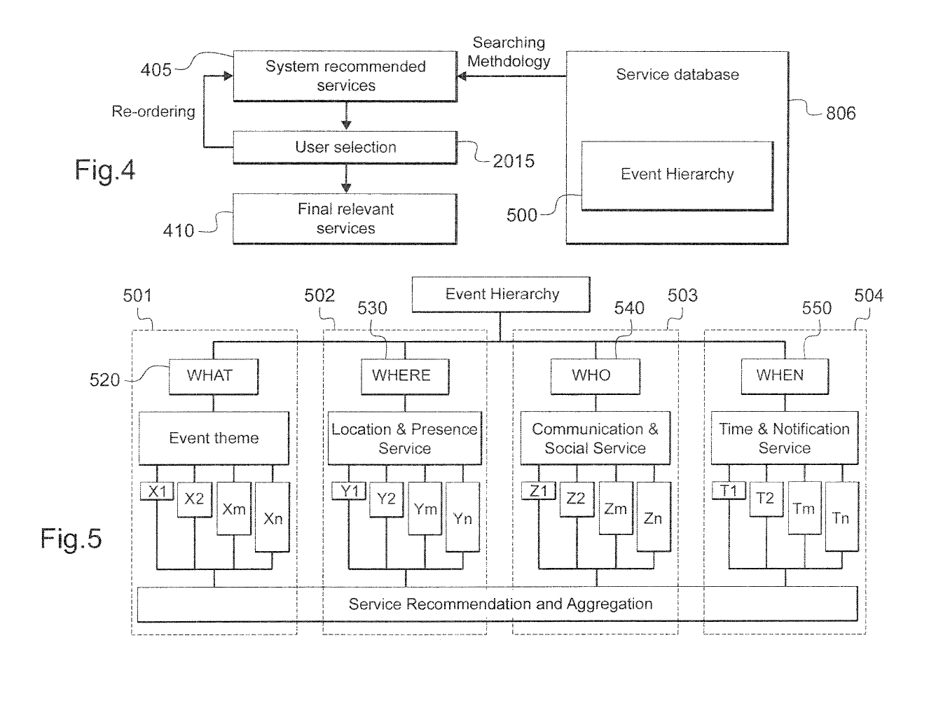

FIG. 4 is an exemplary block diagram illustrating one methodology for modifying a subset of services based on user selections. For example, an initial search methodology may be executed against the database to identify potentially relevant services as a list of system recommended services 405 based on the event information (e.g., event category). Upon user selection from the system recommended services 405, the system may add the selected service to the final list of services 410 to be added to event 102 within user interface 100. Moreover, the system may reorganize the remaining list of system recommended services 405 based on the user selection. Thus, when the user is returned to service selection interface 350, the user may be presented with the system recommended services 405, but reorganized to reflect the user's previous selection.

For example, where a user has selected an air travel search service for addition to event 102 within user interface 100, the system may recognize that because the user may travel by airplane, a mode of transportation upon arrival may be needed. Therefore, when the user is returned to service selection interface 350, the system recommended services 405 may be reordered such that automobile rental agencies and/or taxi providers are provided as highlighted services 255 and/or listed in a more accessible location than other system recommended services 405.

Notably, user preference on service selection may occur not only when the user configures the same or similar event, but also may occur among different event categories based on reusability of the functionality associated with a service. For example, once a user has chosen a “meeting” event and selected a “TodoList service” from the organization category, subsequent event activities held by the user, such as, for example, a party, may provide the TodoList service as a highlighted service 255 automatically ordered before other organization services. This is based on recognition by the system that there is a reusable functionality “organization” for both event categories of party and meeting.

Alternatively, or in addition, upon selection of a particular service, a user may be presented with a dialog prompting the user to provide selections to other services related to the previously selected service. In other words, in the example above, a user may be asked to indicate selections for rental car, taxi, and/or bus service such that transport may be accomplished upon arrival of the flight, or prompting to select a travel mode provider service.

Because user selections may be stored for developing a user selection history as well as for assisting in ranking particular service selections, highlighted services may also be based on rankings by other users, and/or frequency of selection by other users.

According to some embodiments, user profiles associated with a current user and/or one or more event attendees may be generated and/or stored, for example within database 806. Such user profiles may be identified and accessed for purposes of providing system recommended services 405 based on the user profiles. For example, it may be determined that a dinner invitee is a vegetarian, therefore, it may be possible to provide service suggestions catering to such vegetarian tastes.

Once a user has finished selecting one or more desired services for association with a particular event, data associated with user interface 100 may be generated, and provided to the user via for example, a network, for display on a display device 912 (step 2025). FIG. 3C is an illustration showing an exemplary user interface 100, similar to FIG. 1, including one or more access elements 107-109 in addition to a display of services 115, 116, and 117 in widget format associated therewith. Access elements 107-109 may be present, for example, within a calendar entry displayed within user interface 100.

According to some embodiments, access elements 107-109 may also be present upon accessing a more detailed level view of event 102, for example by clicking on a representation of event 102 within user interface 100 to see event information. In other words an event details page (not shown) may include access elements 107-109 such that the user may access services associated therewith.

As shown at FIG. 3C, a user provided with user interface 100 may access the services associated with access elements 107-109 by, for example, clicking, mousing over, or otherwise selecting one or more of access elements 107-109. Taking action with regard to access elements 107-109 may then cause the associated services to be made accessible in, for example, widget or window format, thus enabling a user to interact with the desired service.

For purposes of the current discussion, services 115-116 are shown in widget form, however one of skill in the art will recognize that such services may be presented in separate windows or in any other suitable format.

Where services represented by access elements 107-109 are shown via a mouse over, widget may be displayed as a “fly out” enabling the user to click thereon to maintain presence of the service. Alternatively a user clicking upon access elements 107-109 may obtain a new “pop-up” window or other suitable display, as desired, enabling interaction with the desired service. Notably it may be possible to configure user interface 100 to perform a desired function (e.g., fly out and or pop-up) as desired.

According to some embodiments, accessing and/or interacting with each service 115-117 may cause identification information (e.g., an identifier and/or origination information) to be sent to a provider of the accessed service, to indicate to the provider from where the request originated. Such a configuration may enable monetization of the system and/or provide feedback to a service provider to, for example, enhance services, among others.

FIG. 5 is a diagram illustrating an exemplary event hierarchy 500 organized using an event category 520, an event location 530, an event date/time 540, and event attendees 550 as primary nodes within the hierarchy. Based on these nodes, functional elements can be arranged according to a “What,” “Where,” “When,” and “Who,” type methodology.

As shown in FIG. 6A, each of the “What,” “Where,” “When,” and “Who,” elements may then comprise a hierarchy (501, 502, 503, 504) of related information organized in a dependent manner. For example, a first layer of the hierarchy for event category 520, the “what,” element may be followed by the related functionalities, and then services related thereto, all pertaining to elements of the event category 520 within hierarchy 500. There are at least two benefits to organizing in this manner: 1) it defines useful functionality inside each event activity/type for purposes of filtering out less useful and/or useless services, (i.e. increases the accuracy of retrieved services); and 2) it provides relationships among different events, thereby enabling reusability of functionality for different events.

An exemplary event category hierarchy 501 consistent with embodiments of the present disclosure is shown at FIG. 6B. In this scenario, the event categories shown are a meeting 650, party 660, and travelling 670, among which travelling 670 has also be reused as a functional sub-requirement for meeting 650. In each of these event activities, at least one reusable functionality organization 680 has been included, having an identical list of specific services associated for each of meeting 650, party 660, and travelling 670. Definition of event category hierarchy 501 may improve accuracy of the searching process, and also enables retrieval of user behavior due to the reusable functionality, to aid in reorganization of system recommended services in response to user selections of the current user as well as other users.

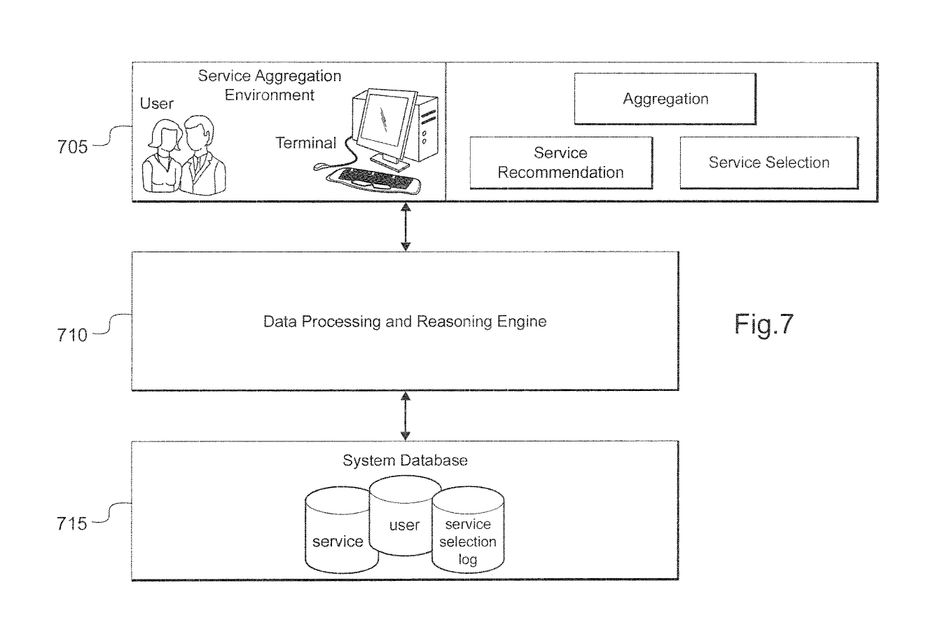

FIG. 7 is a high level illustration of an exemplary logical architecture consistent with embodiments of the present disclosure. Such a system may be implemented by logically maintaining a presentation layer 705, a logic layer 710, and a data layer 715. Software and/or hardware modules associated with presentation layer 705 may be configured to generate and provide data causing display of interfaces (e.g., user interface 100), issue queries requesting information (e.g., system recommended services 405), and receive user selections and data from a client device 104, for example, via a network.

Software and/or hardware modules associated with logic layer 710 may be configured to interface and provide communication with database 806, among other things. For example logic layer 710 may perform queries against database 806 (e.g., to retrieve a list of available services) and perform operations to determine the list of system recommended services 405, among other things, based on information from presentation layer 705.

Software and hardware modules associated with data layer 715 may be configured to provide database and communication services, among others. For example, data layer 715 may comprise database server software, as well as web server software configured to transmit data (e.g., HTML, PHP, JavaScript, etc.) causing display of one or more interfaces on a client device (e.g., user interface 100).

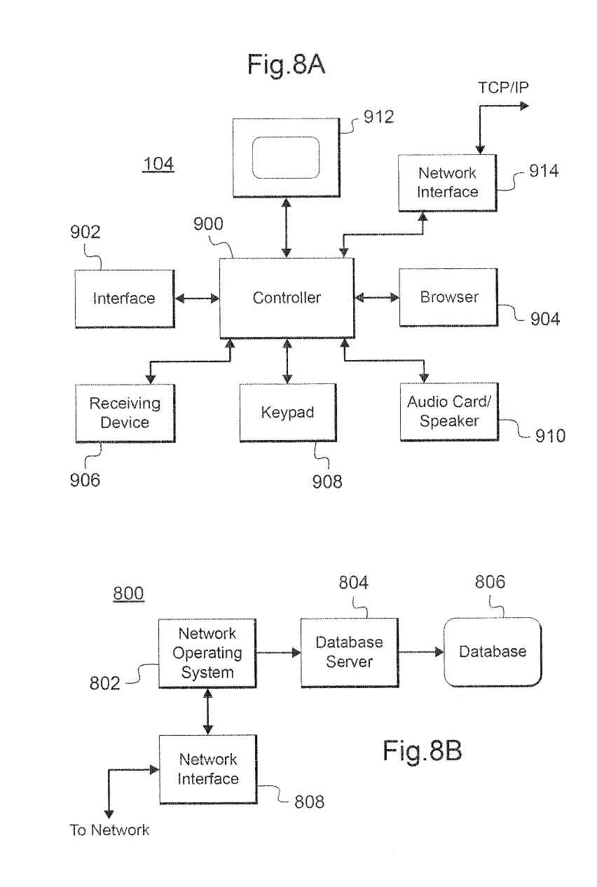

An exemplary computer system consistent with the present disclosure is now described with reference to FIGS. 8A-B. FIG. 8A is a block diagram of an exemplary client device 104 consistent with embodiments of the present disclosure. While elements of FIG. 8A are illustrated to highlight components of exemplary client device 104, one of ordinary skill in the art will recognize that client device 104 may be of any suitable size with more or fewer components as desired. Further, while the components of FIG. 8A are shown as logical devices, one skilled in the art would readily understand that each can be associated with a respective physical device. For example, as described in the foregoing description, client device 104 may comprise a personal computer (e.g., a laptop or desktop computer), a mobile device (e.g., a mobile phone, a tablet computer, a reading appliance, etc.), or any suitable device providing desirable functionality based on embodiments of the present disclosure.

Client device 104 may include any suitable operating system, for example, Windows, Mac OS, Android, LINUX, UNIX, etc. Such operating systems may be proprietary to a manufacturer of client device 104, proprietary in general, open source, or any combination thereof.

It will be understood by those skilled in the art that communication via a network may take place using a single or a combination of protocols and technologies. For example, communication may take place over Hypertext Transfer Protocol (HTTP) and Transmission Control Protocol/Internet Protocol (TCP/IP) for transport and Hypertext Markup Language (HTML), PHP, JavaScript, and PHP for presenting information to users. Further, where available, communication may take place using any combination of additional transport layers including, for example, Global System for Mobile Communications (GSM) and/or Universal Mobile Telecommunications System (UMTS) alone or in combination with other protocols for transmitting information.

Client device 104 may be configured to receive information and/or requests from users, display information to users, and communicate with one or more devices via, for example, a wired and/or a wireless network. As shown, client terminal 104 may include a controller 900, a storage interface 902, a browser 904, a receiving module 906, a keypad 908, an audio card/speaker module 910, a video display 912 (e.g., including touch screen capability), and a network interface 914.

Controller 900 may include a processor and/or memory. Storage interface 902 may provide access to and/or may include one or more software applications stored in local storage which may be configured for displaying graphics to provide information to a user.

For example, instructions associated with browser 904 may be stored or otherwise accessible via storage interface 902. Browser 904 may include any suitable software application, such as, for example, Microsoft Internet Explorer, Mozilla Firefox, Google Chrome, Opera, Apple Safari, or any other suitable software for issuing HTTP requests and receiving HTTP responses over network 100. For example, browser 904 may be configured to request a specific web page such as, for example, a network based user calendar. Browser 904 may also read HTML codes embedded in the web pages received from server 800 to determine how, where, and in what colors and fonts the elements on the web pages may be displayed.

Receiving device 906 may be combined with or used in combination with keypad 908 and network interface 914 for purposes of receiving information from a user or a network, among others. Receiving module 906 may comprise both hardware complements as well as software modules for enabling receipt of information, for example event information.

Keypad 908 may comprise a conventional alphanumeric or numeric key entry device. Keypad 908 may, for example, permit a user to enter, for example information related to one or more events. According to some embodiments, a keypad may not be necessary because a user may be able to input information using touch screen capabilities of video display 912, voice recognition software, or other suitable entry methods.

Audio card/speaker module 910 may comprise a conventional audio card, amplifier, and speaker for presenting audio.

Display device 912 may comprise a conventional video display (e.g., CRT, LCD, LED, etc.) for displaying video graphics and receiving (e.g. touch-screen functionality) user input. According to some embodiments, touch-screen functionality may not be present, and user inputs may be made through keypad 908.

Network interface 914 may comprise any suitable interface for transmitting and receiving information over a network. For example network interface 914 may comprise a wireless interface (e.g., WiFi 802.11(x), GSM, etc.) and/or a wired interface (e.g., USB, RJ45, etc.) Network interface 914 may be configured to transmit requests from, for example, browser 904 and to receive responses via a network (e.g., the Internet). For example event information, service information, and other desirable data (e.g. user interface data) may be transmitted via network between a client device and a server device.

Although not shown, user client terminal 104 may include a printer device to print information. Moreover, user client terminal 104 may also include other input devices, such as a pointing device (e.g., trackball or mouse). In addition, user client terminal 104 may also include head phones, for example, to listen to audio, and text-to-speech and/or speech-to-text conversion software, respectively, to listening to and/or to speak information.

FIG. 8B is a block diagram of an exemplary server 800 consistent with the present invention. As shown, server 800 may include network operating system 802, a database server 804, one or more databases 806, and a network interface 808. Network operating system 802 may include any conventional or future developed operating system (e.g., DOS, Linux, Windows, VMS, VAX, BeOS, Solaris, OS/2, Macintosh, UNIX, etc.). Similar to network interface 914, which was described above in connection with FIG. 8A, network interface 908 may transmit information to and receive information from client devices 104 via any suitable network protocol or combination of protocols.

Database server 804 may provide access to and maintain database 806. In addition, database server 804 may retrieve from database 806 event information, service information, user interface, and other information responding to requests from the user devices 104. Furthermore, the database server 804 may include any suitable database management software, for example, SQL Server, Oracle, MySQL, etc. Database 806 may store user account files, client terminal files, graphical menus, event information, available services, and other multimedia information.

Database 806 may include event hierarchy information, service information, user information, calendar information, and any other suitable information for implementing systems and methods of the present disclosure. While database 806 has generally been referred to in the singular, database 806 may comprise one or more databases. For example, a first database may comprise categories, a second database comprising available services, a third database comprising user information (e.g., use profiles), and a fourth database comprising a service selection history. One of skill in the art will recognize that such examples are not intended as limiting, and database 806 may be configured as desired.

Server 800 may also include storage devices configured to store various code modules comprising instructions, which when executed cause server 800 to perform functions consistent with embodiments of the present disclosure. Software modules may be developed for carrying out various tasks associated with the methods described herein. For example, such modules may include a receiving module, a selection module, and a user interface module and may be developed using objected oriented and/or other development techniques, and using Java, C, C++, BASIC, and/or any suitable programming language. One of skill in the art will recognize that many programming languages exist and likely more will be developed in the future. Therefore, the scope of the present disclosure is not intended to be limiting to any one programming language mentioned herein.

Receiving module may be configured to receive event information, the event information comprising an event date and at least one of an event category and an event location related to the event, a generating module configured to generate a subset of one or more services related to the event based on the event information and the available services. Selection module may be configured to receive a selection of at least one of the one or more services, among others.

User interface module may be configured to generate user interface data causing display of a user interface comprising at least a portion of the event information and an access element linked to the one or more services and/or a visual representation of the one or more services based on the selection, the access element and/or visual representation enabling interaction with the selected one or more services.

Notably, the software modules described herein are intended as exemplary only, and may be fewer or greater as desired. Moreover, such software modules may be present on server 800, client device 104, or any combination thereof.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within generally accepted manufacturing or industry tolerances, and any use of the terms “substantially” and/or “approximately” should be understood to mean falling within such generally accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure. For example, a user may be enabled to subscribe or otherwise agrees to receive addition of additional services from a third-party provider. For example, a user subscribing to this service may not perform a selection of services from service selection interface 350, but upon entering event information and returning to user interface 100, may find access elements added to event 102 by a third-party, for example, specializing in matching event categories and/or locations with desirable services.

In another example, a user utilizing services 115-117 may receive confirmation of such use via user interface 100. For example, where a user has booked a rental car for event 102 using a rental car booking service present within user interface 100 may be provided with an additional access element which may demonstrate such a booking has been performed. In such an example it may be possible to display the access element associated with the rental car booking service as having been completed, for example, but placing a check through the access element.

It is therefore to be understood that numerous modifications may be made to the illustrative embodiments and that other arrangements may be devised without departing from the spirit and scope of the present disclosure as defined by the appended claims.

What is claimed is:

1. A computer implemented method for providing an events based user interface over a network, the method comprising:
receiving by the computer, event information comprising an event date and at least one of an event category and an event location related to an event;
generating a subset of one or more services related to the event from a computerized database, the computerized database comprising a list of available services;
receiving by the computer, a selection from the subset; and
providing via the network, user interface data causing display of a user interface comprising at least a portion of the event information and an access element linked to the one or more services based on the selection, the access element enabling interaction with the selected one or more services.

2. The method of claim 1, wherein the user interface is in a calendar format.

3. The method of claim 2, wherein the access element linked to the one or more services and/or the visual representation of the one or more services is displayed within a date labeled subdivision of the calendar.

4. The method of claim 1, wherein the generating is further based on one or more previous user selections.

5. The method of claim 1, wherein the user interface includes a calendar representation.

6. The method of claim 1, wherein the access elements are presented in at least one of a widget format, a window format and a hyperlink.

7. The method of claim 1, wherein the event categories are chosen from at least one of a meeting event, a travel event, a fashion event, a shopping event, a party, a cooking event, a world event, a business event, a financial event, an art event, a literature event, a history based event, a learning event, a religious event, a health and fitness event, and a sporting event

8. The method of claim 1, wherein the event information further comprises at least one event attendee.

9. The method of claim 1, wherein the service is selected from at least one of a locally hosted service and a web hosted service.

10. The method of claim 1, wherein the available services are selected from one or more of a language translator, a to-do list service, a messaging service, a bookmarking service, a trip booking service, a trip advisor, a calculator, a route planner, a point of interest locator, a currency converter, a classified advertisement provider, a budget planner, a recipe finder, a news service, a banking service, a game provider, a video provider, a book provider, a tour provider, a weather service, a vehicle rental service, and a fitness service.

11. The method of claim 1, wherein the network is the Internet.

12. The method of claim 1, further comprising causing the subset of one or more services related to the event to be displayed.

13. The method of claim 1, wherein the generating is further based on an event category hierarchy.

14. The method of claim 1, further comprising:
saving the selection of services, and
ranking the selection, based on the event category and the user selection history.

15. The method of claim 14, wherein the ranking is based on at least one of a frequency of selection by the user and a frequency of selection among a plurality of users.

16. The method of claim 1, wherein the access elements are configured to provide request origin information to a service host.

17. The method of claim 1, wherein the user interface is configured to enable the user to assign one or more default services to an event category.

18. The method of claim 1, wherein the user interface is configured to allow the user to subscribe to a third-party provider, the third-party provider having authority to add to the user interface one or more access elements related to the event, independently of the user.

19. The method of claim 1, wherein one or more reminders associated with the event are sent to the user, the reminders including a reference to the one or more selected services.

20. A computer system configured to provide one or more user interface elements in connection with an event, the computer system comprising:
a database comprising one or more available services;
a receiving module configured to receive event information, the event information comprising an event date and at least one of an event category and an event location related to the event;
a generating module configured to generate a subset of one or more services related to the event based on the event information and the available services;
a selection module configured to receive a selection of at least one of the one or more services; and
a user interface module configured to generate user interface data causing display of a user interface comprising at least a portion of the event information and an access element linked to the one or more services and/or a visual representation of the one or more services based on the selection, the access element and/or visual representation enabling interaction with the selected one or more services.
